(19) United States
(12) Patent Application Publication
(10) Pub. No.: US 2017/0185937 A1
(43) Pub. Date: Jun. 29, 2017

(54) AIRCRAFT FLIGHT DATA EVALUATION SYSTEM

(71) Applicant: SAFRAN AIRCRAFT ENGINES, Paris (FR)

(72) Inventors: Julien Alexis Louis Ricordeau, Paris (FR); Alexandre Anfriani, Alfortville (FR); Aurélie Gouby, Quincy Sous Senart (FR); Jérôme Henri Noël Lacaille, Rosny Sous Bois (FR)

(21) Appl. No.: 15/388,185

(22) Filed: Dec. 22, 2016

(30) Foreign Application Priority Data
Dec. 23, 2015 (FR) 15 63183

(51) Int. Cl. G06Q 10/06; G07C 5/00; B64F 5/60

(52) U.S. Cl. CPC G06Q 10/06395; B64F 5/60; G07C 5/008

(57) ABSTRACT

A flight data evaluation system to optimise operations of an aircraft, comprising: an acquisition circuit (3) configured to collect observation data (D₁−Dₙ) related to a fleet of aircraft, and a processing circuit (5) configured: to assign quality values (Qᵢ) to the observation data by applying predetermined learning models (M₁−Mₙ) to them corresponding to their contexts, thus generating observation data enriched with quality values, to define indicators (21, 23) relative to specific elements of the aircraft, to compare the quality value (Qᵢ) of each observation data (Dᵢ) with a predetermined threshold (S), and to analyse the observation data as a function of their quality values so as to optimise aircraft operations.

### TECHNICAL DOMAIN

This invention relates to the domain of aircraft operations and more specifically to the automatic validation and evaluation of flight data to optimise operation of an aircraft.

### STATE OF PRIOR ART

Data recorded during flight of an aircraft are usually used to check that the different aircraft equipment is functioning correctly.

For example, these data are used to monitor the aircraft engine to be able to detect any anomalies. In fact, they can be used to analyse the behaviour of the engine throughout the start-up process, to analyse its thermodynamic performances, to detect if filters are fouled, to analyse oil consumption, etc.

Flight data records may include abnormal or corrupt data, for example due to an anomaly, a software modification, a micro power cut, or an equipment failure. In this case, data recorded during flights of a fleet of aircraft cannot be evaluated efficiently so that improvements to aircraft operability can be recommended.

Furthermore, there is a very wide variety of measurements that depend very closely on the upgrade context of the aircraft. Furthermore, due to the frequent frequency of flights, the data volume is much too large for these data to be verified manually.

Consequently, the purpose of this invention is to disclose a system for automatic verification of the quality of flight data and evaluation of quality data to be able to make operational usage recommendations to improve aircraft operations.

### PRESENTATION OF THE INVENTION

This invention is defined by a flight data evaluation system to optimise aircraft operations, comprising:
an acquisition circuit configured to collect observation data related to a fleet of aircraft, and
a processing circuit configured:
   to assign quality values to said observation data by applying predetermined learning models to them corresponding to their contexts, thus generating observation data enriched with quality values,
   to define indicators (21, 23) relative to specific elements of the aircraft,
   to compare the quality value (Qᵢ) of each observation data (Dᵢ) with a predetermined threshold (S), and
   to validate said observation data as a function of their quality values so as to optimise aircraft operations.

Thus, enrichment of observation data by quality values to evaluate clean observation data to make precise analyses on manoeuvres that the aircraft is made to perform, to improve the precision of surveillance tools.

Advantageously, the processing circuit is configured:
to calculate a residue between the value of each observed data and the corresponding value predicted by the learning model, and
to calculate the quality value of the observation data by comparing said residue with an error value allowed by the corresponding learning model.

Advantageously, each observation data with a quality value less than a predetermined threshold is either weighted, or corrected, or discarded.

According to a first example of the type of processing, observation data comprise measurements of aircraft turnaround times and internal temperature measurements of aircraft engines. In this case, the processing circuit is configured to optimise aircraft operations by determining a turnaround time distribution as a function of engine internal temperatures for a fleet of aircraft.

According to another example, observation data include temperature measurements at aircraft engine intakes during the phases in which said engines are stopped. In this case, the processing circuit is configured to optimise aircraft operability by determining a temperature distribution at the intakes to engines in a fleet of aircraft.

According to a third example, observation data comprise fuel consumption measurements and piloting parameter measurements. In this case, the processing circuit is configured to optimise aircraft operations by determining a fuel consumption distribution as a function of piloting parameters for a fleet of aircraft.

Advantageously, the turnaround time distribution and/or the engine intake temperature distribution and/or the fuel consumption distribution is (are) correlated to a total consumption and/or wear of the equipment on a flight.

This makes it possible to make recommendations about aircraft turnaround times, choices of the assignment or aircraft to routes with more or less severe environments, and aircraft piloting parameters for optimum operability and fuel consumption.

Advantageously, the system comprises an operations database to store observation data enriched with quality values.

The invention also aims at a flight data operations method to optimise operability of an aircraft, including the following steps:
acquire observation data related to a fleet of aircraft,
assign quality values to said observation data by applying predetermined learning models corresponding to their contexts, thus generating observation data enriched with quality values,
define indicators (21, 23) relative to specific elements of the aircraft,
compare the quality value (Qᵢ) of each observation data (Dᵢ) with a predetermined threshold (S), and
validate said observation data as a function of their quality values so as to optimise operability of the aircraft.

The invention also relates to a database comprising observation data enriched with quality values created using the evaluation method disclosed by this invention.

### BRIEF DESCRIPTION OF THE DRAWINGS

Other special features and advantages of the system and the method according to the invention will become clearer after reading the following description given for information and that is in no way limitative, with reference to the appended drawings on which:

FIG. 1 diagrammatically illustrates a system for evaluation of flight data to optimise aircraft operations, according to a first preferred embodiment of the invention;

FIG. 2 diagrammatically illustrates an example of a method of constructing learning models, according to one embodiment of the invention;

FIG. 3 diagrammatically illustrates a method of determining quality values and enrichment of observation data, according to a preferred embodiment of the invention;

FIG. 4 is a graph illustrating an example of observation data in comparison with data from the corresponding learning model;

FIG. 5 diagrammatically illustrates a method of evaluating enriched observation data, according to one embodiment of the invention; and

FIG. 6 diagrammatically illustrates an example evaluation of observation data related to a specific indicator, according to one embodiment of the invention;

### DETAILED PRESENTATION OF PARTICULAR EMBODIMENTS

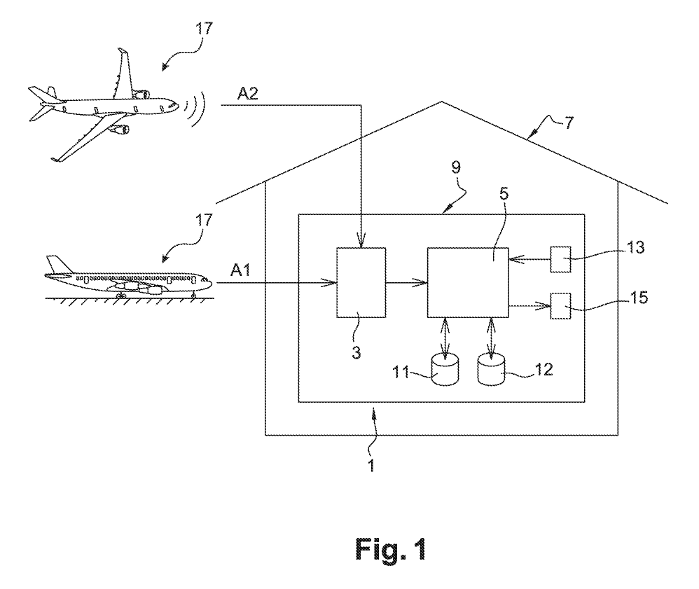

FIG. 1 diagrammatically illustrates a system for the evaluation of flight data to optimise aircraft operations, according to a first embodiment of the invention.

The evaluation system 1 comprises an acquisition circuit 3 and a processing circuit 5.

More particularly, the evaluation system 1 is installed in a station on the ground 7 and comprises a computer system 9 including acquisition circuits 3 and processing circuits 5 and storage units 11 and the normal input peripherals 13 and output peripherals 15. It will be noted that the storage units may comprise computer programs including code instructions adapted to use the data evaluation method according to the invention. These computer programs may be executed by the processing circuit 5 in relation with the storage units 11 and the acquisition circuit 3.

During each flight, each aircraft 17 collects parameters or observation data related to the mission and records these parameters or data on onboard storage means. These data are derived from specific measurements or data acquired by onboard sensors or computers providing information about physical or logical elements of equipment on the aircraft 17 and in particular about its engines. In general, the data are temporal data and are dependent of flight conditions of the aircraft.

For example, observation data comprise measurements of aircraft turnaround times, measurements of engine internal temperatures, measurements of external temperatures at the engine air intake, fuel consumption measurements, measurements of piloting parameters, etc.

Observation data for each aircraft can be downloaded regularly, for example after each flight (arrow A1), to be recovered by the evaluation system 1.

It will be noted that part of these data may also be transmitted (arrow A2) by aircraft at the ground station in real time. During each flight, an aircraft 17 sends information about its operation, for example using a message system known as ACARS (Aircraft Communication Addressing and Reporting System) or any other communication means for sending information. These data are normally retrieved by ground stations in real time to be processed immediately in the case of obvious anomalies and otherwise to be archived with all data for the aircraft fleet. Additional data recorded in onboard systems can also be downloaded manually.

Observation data related to a fleet of aircraft collected by the acquisition circuit 3 are stored consistently in the storage units 11.

According to the invention, the processing circuit 5 is configured to assign quality values or scores to observation data by applying the corresponding predetermined learning models to them, depending on their contexts. In other words, the processing circuit 5 compares each observed data with an adapted learning model depending on the context or the flight phase so as to generate observation data enriched by quality values.

It will be noted that an item of observation data is usually associated with a parameter or a temporal observation signal recorded during a flight and consequently, the corresponding quality value is also temporal (i.e. is represented by a temporal quality signal).

It will also be noted that a learning model is a model created from data deemed to be sound (see FIG. 2). An example of the construction of learning models is described by Seichepine et al, in the article entitled “Data mining of flight measurements”. More specifically, this document describes a method of construction of learning models to detect anomalies. The method is only concerned with abnormal data and does not reveal any enrichment of the observed data.

In contrast, the processing circuit 5 of this invention scans each observation data so as to assign a quality value to it, thus automatically validating quality and easily used data.

For example, the quality value can be calculated using a transfer function associating an imprecision with each observation data in response to an imprecision of the corresponding data predicted by the learning model.

As a variant, the quality value can be calculated by a match indicator defining the measurement of a distance between the observation data and the corresponding prediction by the learning model. The match indicator is used to check that appropriate data are used, in other words that resemble data that were used during learning. In other words, it is a distance from the initial data that were used to construct the model. Examples of quality indicators are described in patent FR2957170 deposited by the applicant.

Advantageously, the processing circuit 5 estimates quality values by implementing an algorithm using a multi-agent type technology. In this case, each agent manages a specific measurement context and only deals with a subset of the observation data. Agents are then automatically organised by competence. Thus, when new data arrive, the most competent agents will be used for each temporal segment, to perform an analysis of the data quality. The final decision procedure is obtained by merging the most competent agents on each data segment. Finally, a quality value is assigned to each observation data.

Alternately, the population of agents can change with the arrival of new data, to refine their previously determined skills or to construct others. In this case, the processing circuit implements a genetic type of learning algorithm.

It will be noted that more classical filter tools can also be used to analyse the data quality.

Moreover, observation data enriched with quality values are advantageously stored in an evaluation base 12. More particularly, a specific quality value is assigned to each data when observation data are added into the data base. The evaluation database 12 then contains the quality information so that the processing circuit 5 can analyse observation data as a function of their quality values so as to optimise aircraft operations or to increase the precision of monitoring tools. Aircraft operations refers to manoeuvres that the aircraft is made to perform.

Due to the enriched evaluation data, the processing circuit 5 can evaluate quality observation data (not affected by incorrect data) to make statistical analyses or for very high precision data mining. For example, the analysis results may include precise recommendations about the improvement of manoeuvres on an aircraft and/or the improvement of monitoring tools. The precision of monitoring tools will be automatically improved simply by avoiding low quality data.

FIG. 2 diagrammatically illustrates an example of a method for constructing learning models, according to the invention;

Indeed, models are constructed during a learning phase that will subsequently be used to determine quality values for all observation data.

Step E1 consists of using a filter F1 to filter learning data by transforming some digital data into continuous signals and eliminating obviously aberrant data, for example outside the physical limits of the measured magnitude.

Step E2 applies to an unsupervised classification of the variables. There is a very large number of variables (several thousand) in recorded flight data on an aircraft, many of which are redundant or equivalent and therefore it is important to select the most representative variables for the construction of models.

A predetermined measurement is used (for example, a mutual information measurement) to calculate the distances between variables in pairs so as to define subsets e₁−eₙ of homogeneous interrelated variables. Each subset is then enriched by new variables created by non-linear transformations on its initial variables so as to extract a base representative of the subset. This makes it possible to keep all information with the smallest possible number of variables and to predict each variable making use of other variables belonging to the same subset.

Step E3 relates to the construction of the different learning models M₁−Mₙ starting from a variable representative of each subset e₁−eₙ. This construction may be made for example using the LASSO technique.

Advantageously, the learning models are Gaussian models constructed as a function of the different flight phases. An aircraft engine usually functions in the same way as a function of clearly defined flight phases including the start engine phase, then taxiing, takeoff, climb cruising speed, approach, landing, reverse and stop engine.

Step E4 relates to estimating the parameters of an error model Erᵣ−Erₙ associated with each learning model M₁−Mₙ. Each error model Erᵣ−Erₙ indicates the errors that can be accepted or tolerated by the corresponding learning model. An example of calculation of error models is outlined by Seichepine et al, in the article entitled <<Data mining of flight measurements>>.

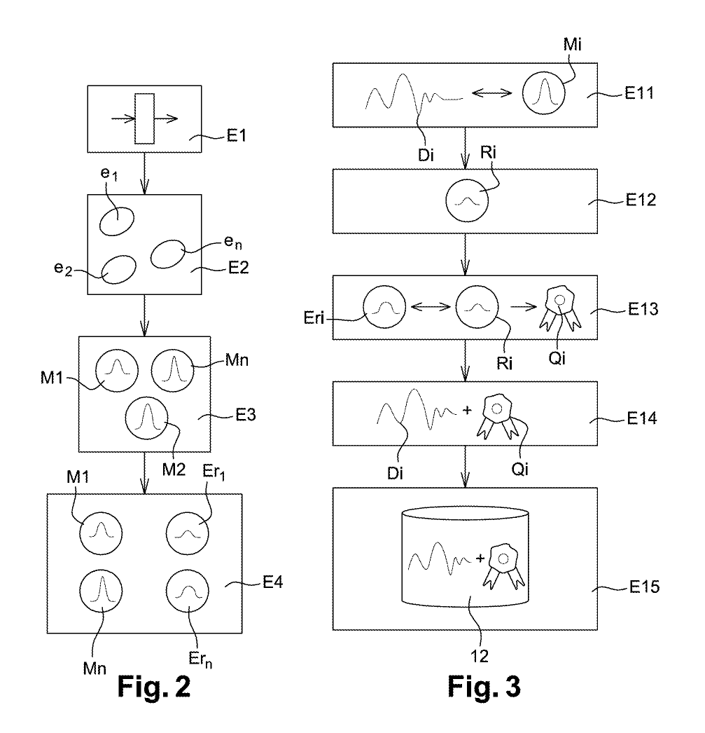

FIG. 3 diagrammatically illustrates a method of determining quality values and for enrichment of observation data, according to a preferred embodiment of the invention.

In step E11, the processing circuit 5 is configured to apply the most relevant learning model Mᵢ for the specific flight phase to each new observation data Dᵢ recorded during the flight phase.

The models M₁−Mₙ were constructed during the learning phase, as a function of the different flight phases knowing that it is impossible to build a single Gaussian model for all flight phases. Each variable behaves differently depending on the context or the flight phase during which it is observed.

In step E12, the processing circuit 5 is configured to calculate a residue Rᵢ between the value of each recorded observation data Dᵢ and the value predicted by the corresponding learning model Mᵢ. In other words, the processing circuit 5 calculates the error made by the observed data relative to the learning model.

In step E13, the processing circuit 5 is configured to estimate the quality value Qᵢ of observation data Dᵢ by comparing the residue Rᵢ with an error value Erᵢ tolerated by the corresponding learning model Mᵢ. In other words, the processing circuit 5 compares the error Rᵢ of the observed data Dᵢ with the error Erᵢ (defined by the errors model) allowed by the learning model and assigns a quality value Qᵢ as a function of the difference between these two errors. A small difference means that the quality of the observed data is good and therefore that the corresponding quality value Qᵢ is high, while a large difference between the two errors means that the observed data is poor quality and therefore the assigned quality value Qᵢ is low. It will also be noted that a large extrapolation error does not always mean that the quality of the tested data is low: the agent itself may have limited competence.

Thus, the quality value Qᵢ may simply be equal to the distribution function of the absolute value of the residue.

As a variant, if it is considered that the error model Erᵢ is a Gaussian model and the residue Rᵢ follows a folded-normal law, the quality value Qᵢ corresponds to the absolute value of the residue.

The quality value Qᵢ can thus be defined simply by a quality score between 0 and 1. A score with value 1 indicates that the data is very good, while a score equal to 0 indicates that the data is erroneous.

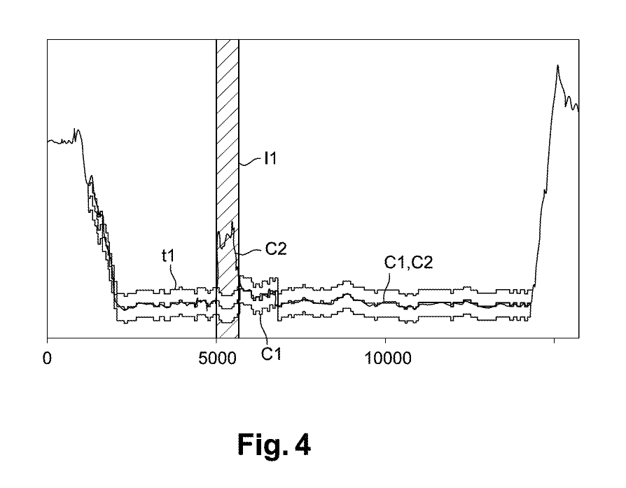

FIG. 4 is a graph illustrating an example of observation data in comparison with the data from the corresponding learning model.

Curve C1 corresponds to the average value defined by the learning model and the tolerance tube or confidence tube t1 corresponds to the standard deviation of this value. Curve C2 represents the observation data. The observation data C2 is considered to be good as long as it lies inside this confidence tube t1. The quality value Qᵢ is high when the observation data is close to the average value of the learning model and is low otherwise. This example shows that at about instant 5000 and during a small interval I1 (vertical band), the observation data C2 goes outside the confidence tube t1, and in this case the quality value Qᵢ on this interval I1 is very low (almost zero). Furthermore, outside this interval I1 and therefore for which the associated quality value is almost 0, the two curves C1 and C2 are almost coincident and therefore the associated quality factor will be almost 1.

In step E14, the processing circuit 5 is configured to add the quality value or score Qᵢ to each observation data Dᵢ, thus generating enriched observation data.

In step E15, the processing circuit 5 is configured to store observation data enriched with the corresponding quality values in the evaluation database 12.

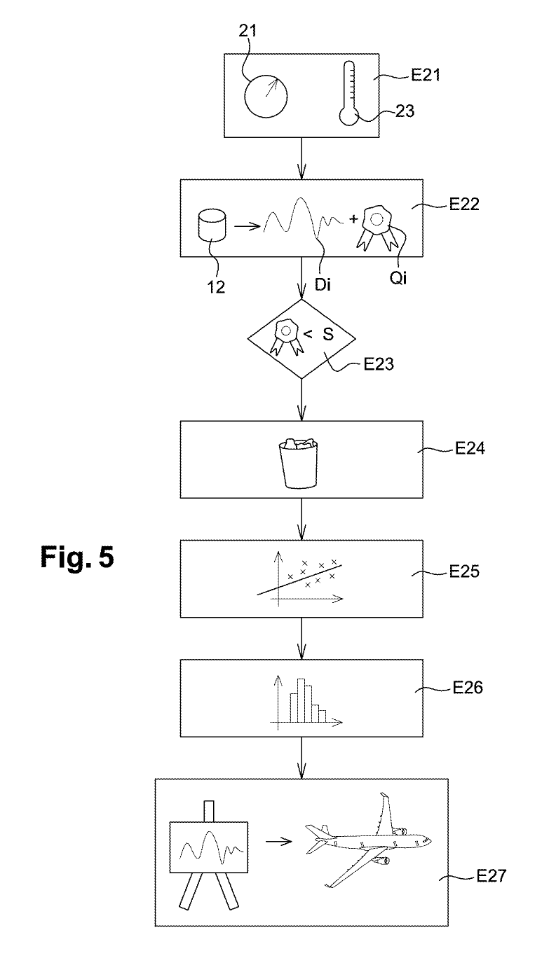

FIG. 5 diagrammatically illustrates a method of the evaluation of enriched observation data, according to one embodiment of the invention.

In step E21, the processing circuit 5 is configured to define relevant indicators 21, 23 related to specific elements or tasks or manoeuvres for aircraft.

Indicators specific to physical elements indicating a particular element of the engine or the aircraft or to logical elements indicating a specific task or situation of an entire set of elements of the engine or the aircraft, can be defined from observation data.

For example, one indicator might correspond to a statistical distribution of aircraft turnaround times, aircraft engine internal temperatures, aircraft engine external temperatures, fuel consumptions, times necessary for an engine to reach the maximum acceleration during each start up, temperature gradients in engine exhaust gases, etc.

In step E22, the processing circuit 5 is configured to acquire observation data enriched in relation to the indicator of interest defined in the previous step, from the evaluation database 12.

In steps E23 and E24, the processing circuit 5 is configured to automatically validate the enriched observation data.

More particularly in step E23, the processing circuit 5 is configured to compare the quality value Qᵢ of each observation data Dᵢ with a predetermined threshold S.

In step E24, the processing circuit 5 is configured to discard observation data with a quality value below the predetermined threshold so as to evaluate only data with a quality value higher than this threshold. Thus, only good quality data are evaluated.

According to a first variant, at least some of the observation data with a quality value below the predetermined threshold are corrected according to expertise criteria. It is advantageous to evaluate the largest possible number of observation data.

According to a second variant, the observation data are weighted as a function of their corresponding quality values. For example, a weight equal to its quality value can be assigned to each observation data.

In step E25, the processing circuit 5 can advantageously be configured to standardise observation data so that they are independent of the outside context. This step is optional and can be applied to a fraction of the observation data.

Each measurement collected during a flight mission is made under particular external or internal conditions. These conditions that can have an impact on readings of indicators can be measured and recorded as exogenic data. External conditions can include outside temperatures and pressures, the attitude and relative speed of the aircraft, the place of the flight (above the sea, the desert, the earth, etc.), the airport location, weather conditions (rain, snow, hail, etc.) and relative humidity, etc. Internal conditions may apply to the specific use of the engine (shaft speed, temperature of exhaust gases, fuel type, etc.). One example of exogenic data is the oil temperature just before starting the engine that can be considered as context data that differentiates two start types (cold start or hot start).

Standardisation is based particularly on a step to normalise endogenic variables based on a regression model. It will be noted that the results of the regression model can be improved by taking account of additional variables constructed from calculations using initial exogenic variables to form a set of context variables.

Thus, normalisation can be done using a generalised linear regression model defined on a context variables space generated by analytic combinations (polynomial and/or non polynomial) of exogenic variables.

In step E26, the processing step 5 is configured to construct the indicator of interest from possibly standardised observation data related to the indicator.

In step E27, the processing circuit 5 is configured to make statistical analyses on the indicator in order to suggest recommendations for operational uses of aircraft in order to optimise their operability. For example, the recommendations may be represented in the form of graphs or may be formulated as “best practices”.

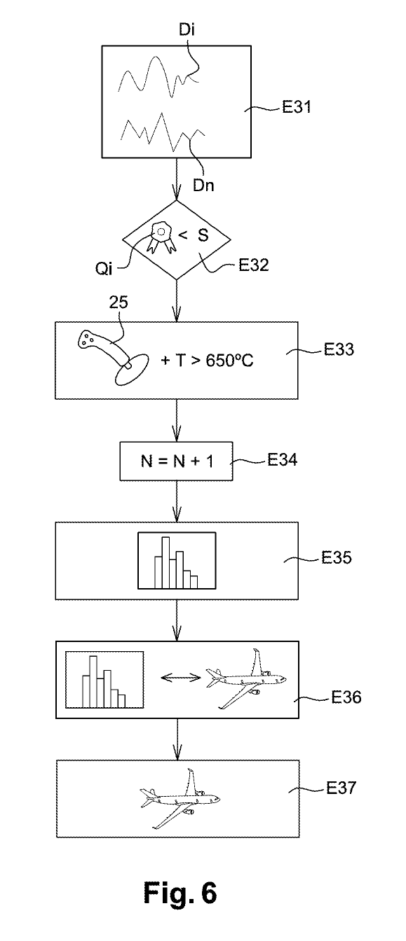

FIG. 6 diagrammatically illustrates an example evaluation of observation data related to a specific indicator, according to one embodiment of the invention.

According to this example, the indicator provides information about the distribution of turnaround times as a function of engine internal temperatures. This distribution can be made for a fleet of aircraft, per aircraft, per airport, etc.

More specifically, in step E31, the processing circuit 5 acquires observation data D₁−Dₙ comprising measurements of aircraft turnaround times and internal temperature measurements of aircraft engines.

Step E32 is a test made on each observation data Dᵢ acquired in the previous step. If the quality value Qᵢ of current data is less than a threshold value 5 (for example equal to 0.7), the processing circuit 5 will ignore the data and the test will be restarted for the next data. On the other hand, if the test result is negative (i.e., the quality value of the current data is more than S), the next step E33 is started.

Steps E33 and E34 define the following loop: a counter is incremented as long as the aircraft throttle 25 is on the “ground idle” position and the engine temperature is more than 650° C. This information is calculated for each engine, for each aircraft and for each flight.

In step E35, the processing circuit 5 displays the distribution of time spent on the ground for internal engine temperatures of more than 650° C. for an entire fleet, by aircraft, by airport, by day, etc., on a screen.

In step E36, the processing circuit 5 is configured to correlate the distribution of time spent on the ground with dysfunctions or performances of aircraft engines.

Thus, in step E37 due to the correlations from the previous step, the processing circuit 5 is configured to help make operational usage recommendations with the aim of optimising aircraft operations.

According to a second example, the indicator could relate to a distribution of external temperatures on the ground.

In the same way as in the previous example, the processing circuit 5 acquires observation data comprising external temperature measurements on the ground.

For a given aircraft, as long as the aircraft is on the ground with the engines stopped (i.e. zero engine speed), the external temperature T₀ at the engine intake is recorded by the aircraft (for example in a ACMS type system connected to the FADEC). This data can be corrupt at the time of the data acquisition (sensor, harness, connector defect) or transmission. Thus, the processing circuit assigns a lower quality value in the case of corrupt data. For example, for an acquisition on an aircraft with the engine stopped before a flight (during a time interval [t₁, t₂]), the quality value is calculated for each acquired value of T₀ during [t₁, t₂] and is then added to the operations database.

The processing circuit 5 determines the distribution of intake temperatures for an entire fleet, by aircraft, by airport, by day, etc. Finally, the processing circuit analyses this distribution to see the influence of external temperatures on the ground, on operation of the engine so as to make operational usage recommendations to be used to optimise aircraft operations.

According to a third example, the indicator could correspond to a distribution of fuel consumptions as a function of piloting parameters.

In the same way as in the previous examples, the processing circuit 5 acquires observation data comprising fuel consumption measurements and piloting parameter measurements. In the next step, the processing circuit determines the distribution of fuel consumptions as a function of piloting parameters. Finally, the processing circuit analyses the distribution to make recommendations for operational use of aircraft so as to achieve fuel savings.

Advantageously, the processing circuit 5 is configured to monitor parameters recorded during the flight for a fleet of aircraft, and to monitor that recommendations are applied correctly, so that the impacts of using a particular recommendation on a given flight can be quantified.

1. Flight data evaluation system to optimise operations of an aircraft, comprising:
an acquisition circuit (3) configured to collect observation data (D₁−Dₙ) related to a fleet of aircraft, and
a processing circuit (5) configured:
to assign quality values (Qᵢ) to said observation data by applying predetermined learning models (M₁−Mₙ) to them corresponding to their contexts, thus generating observation data enriched with quality values,
to define indicators (21, 23) relative to specific elements of the aircraft,
to compare the quality value (Qᵢ) of each observation data (Dᵢ) with a predetermined threshold (S), and
to validate said observation data as a function of their quality values so as to optimise aircraft operations.

2. System according to claim 1, characterised in that the processing circuit (5) is configured:
to calculate a residue between the value of each observed data and the corresponding value predicted by the learning model, and
to calculate the quality value of the observation data by comparing said residue with an error value allowed by the corresponding learning model.

3. System according to claim 1, characterised in that each observation data with a quality value less than a predetermined threshold is either weighted, or corrected, or discarded.

4. System according to claim 1, characterised in that observation data include measurements of aircraft turnaround times and internal temperature measurements of aircraft engines, and in that the processing circuit is configured to optimise aircraft operations by determining a turnaround time distribution as a function of engine internal temperatures for a fleet of aircraft.

5. System according to claim 1, characterised in that observation data include temperature measurements at aircraft engine intakes during the phases in which said engines are stopped, and in that the processing circuit is configured to optimise aircraft operations by determining a distribution of engine intake temperatures for a fleet of aircraft.

6. System according to claim 1, characterised in that observation data comprise fuel consumption measurements and piloting parameter measurements, and in that the processing circuit is configured to optimise aircraft operations by determining a fuel consumption distribution as a function of piloting parameters for a fleet of aircraft.

7. System according to claim 1, characterised in that the turnaround time distribution and/or the engine intake temperature distribution and/or the fuel consumption distribution is (are) correlated to a total consumption and/or wear of the equipment on a flight.

8. System according to claim 1, characterised in that the system comprises an operations database to store observation data enriched with quality values.

9. Flight data evaluation method to optimise aircraft operations, comprising the following steps:
acquire observation data related to a fleet of aircraft,
assign quality values (Qi) to said observation data by applying predetermined learning models corresponding to their contexts, thus generating observation data enriched with quality values, and
define indicators (21, 23) relative to specific elements of the aircraft,
compare the quality value (Qᵢ) of each observation data (Dᵢ) with a predetermined threshold (S), and
validate said observation data as a function of their quality values so as to optimise aircraft operations.

10. Database comprising observation data enriched with quality values created using the method according to claim 9.
